(19) United States
(12) Patent Application Publication
(10) Pub. No.: US 2025/0238118 A1
(43) Pub. Date: Jul. 24, 2025

(54) METHOD, APPARATUS, DEVICE, AND STORAGE MEDIUM OF INFORMATION INTERACTION

(71) Applicant: Beijing Zitiao Network Technology Co., Ltd., Beijing (CN)

(72) Inventors: Xiang JIANG, Beijing (CN); Runqiong WANG, Beijing (CN); Guangliu ZHANG, Beijing (CN); Haoting HUANG, Beijing (CN)

(21) Appl. No.: 19/014,820

(22) Filed: Jan. 9, 2025

(30) Foreign Application Priority Data
Jan. 22, 2024 (CN) 202410090757.8

(51) Int. Cl. G06F 3/0482; G06F 3/16

(52) U.S. Cl. CPC G06F 3/0482; G06F 3/167

(57) ABSTRACT

According to embodiments of the disclosure, a method, an apparatus, a device, and a storage medium of information interaction are provided. The method includes: in response to an interaction between a user and a digital assistant being triggered, displaying a scene selection entry, a local resource addition entry and a first input provision entry corresponding to a first input mode in an interaction interface between the user and the digital assistant, the first input mode including at least one of a voice input mode or a text input mode; and receiving interaction information of the user for the digital assistant via at least one of the scene selection entry, the local resource addition entry, and the input provision entry.

### CROSS-REFERENCE

This application claims priority to Chinese Application No. 202410090757.8, filed on Jan. 22, 2024, and entitled “METHOD, APPARATUS, DEVICE, AND STORAGE MEDIUM OF INFORMATION INTERACTION”, the entirety of which is incorporated herein by reference.

### FIELD

Example embodiments of the present disclosure generally relate to the field of computers, and more particularly, to a method, an apparatus, a device, and a computer-readable storage medium of information interaction.

### BACKGROUND

With the development of information technologies, various terminal devices can provide various services for people in the aspects of work, life, and the like. An application providing a service may be deployed in a terminal device, and the terminal device or the application may provide a digital assistant type function for a user, so as to assist the user in using the terminal device or the application. How to provide a user with a simpler interactive manner and visual design is a technical problem to be explored currently.

### SUMMARY

In a first aspect of the disclosure, a method of information interaction is provided, the method including: in response to an interaction between a user and a digital assistant being triggered, displaying a scene selection entry, a local resource addition entry and a first input provision entry corresponding to a first input mode in an interaction interface between the user and the digital assistant, the first input mode comprising at least one of a voice input mode or a text input mode; and receiving interaction information of the user for the digital assistant via at least one of the scene selection entry, the local resource addition entry, and the input provision entry.

In a second aspect of the present disclosure, an apparatus of information interaction is provided. The apparatus includes a display module configured to, in response to an interaction between a user and a digital assistant being triggered, display a scene selection entry, a local resource addition entry and a first input provision entry corresponding to a first input mode in an interaction interface between the user and the digital assistant, the first input mode comprising at least one of a voice input mode or a text input mode; and a receiving module configured to receive interaction information of the user for the digital assistant via at least one of the scene selection entry, the local resource addition entry, and the input provision entry.

In a third aspect of the present disclosure, an electronic device is provided. The electronic device includes at least one processing unit; and at least one memory coupled to the at least one processing unit and storing instructions for execution by the at least one processing unit. The instructions, when executed by the at least one processing unit, cause the electronic device to perform the method according to the first aspect.

In a fourth aspect of the present disclosure, a computer readable storage medium is provided. The computer readable storage medium has a computer program stored thereon, and the computer program is executable by a processor to implement the method according to the first aspect.

It should be understood that what is described in this section is not intended to limit the critical features or essential features of the embodiments of the present disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a schematic diagram of an initial example interface for performing information interaction according to some embodiments of the present disclosure.

FIGS. 3A to 3C illustrate schematic diagrams of example interfaces for adding local resources according to some embodiments of the present disclosure;

FIGS. 4A to 4B illustrate schematic diagrams of example interfaces for performing information interaction in a voice input mode according to some embodiments of the present disclosure;

FIGS. 5A to 5D illustrate schematic diagrams of example interfaces for performing information interaction in a voice input mode according to some other embodiments of the present disclosure;

FIGS. 6A to 6H illustrate schematic diagrams of example interfaces for performing information interaction in a text input mode according to some embodiments of the present disclosure;

FIG. 7 illustrates a flowchart of an information interaction process according to some embodiments of the present disclosure;

FIG. 8 illustrates a schematic block diagram of an information interaction apparatus according to some embodiments of the present disclosure; and

FIG. 9 illustrates a block diagram of an electronic device capable of implementing one or more embodiments of the present disclosure.

### DETAILED DESCRIPTION

It should be understood that, before the technical solutions disclosed in the embodiments of the present disclosure are used, the related users should be of the type, application scope, and application scenario of the personal information involved in this disclosure in an appropriate manner and the related user's authorization shall be obtained, in accordance with relevant laws and regulations.

For example, in response to receiving an active request from a user, prompt information is sent to the relevant user to explicitly prompt the relevant user that the operation requested to be performed will require acquiring and using personal information of the related user, so that the related user may autonomously select, according to prompt information, whether to provide information for software or hardware such as an electronic device, an application, a server, or a storage medium that executes the operation of the technical solutions of the present disclosure.

As an optional but non-limiting implementation, in response to receiving an active request of a related user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide information to the electronic device.

It should be understood that the above notification and user authorization process are only illustrative which do not limit the implementation of this disclosure. Other methods that meet relevant laws and regulations can also be applied to the implementation of this disclosure.

It should be understood that the data involved in the technical solution (including but not limited to the data itself, the acquisition or use of the data) should comply with the requirements of the corresponding legal regulations and related provisions.

Embodiments of the present disclosure will be described in more detail below with reference to the accompanying drawings. Although some embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes but are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

Herein, unless explicitly stated otherwise, “performing a step in response to A” does not mean that the step is performed immediately after “A”, but may include one or more intermediate steps.

In the description of the embodiments of the present disclosure, the term “including” and the like should be understood as open-ended including, that is, “including but not limited to”. The term “based on” should be read as “based at least in part on”. The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

### Example Environment

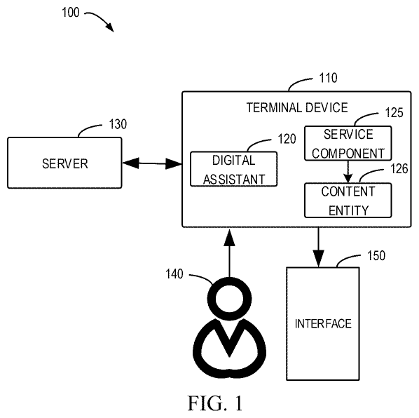

FIG. 1 illustrates a schematic diagram of an example environment 100 in which embodiments of the present disclosure can be implemented. In this example environment 100, a digital assistant 120 and a service component 125 are installed in a terminal device 110. The user 140 may interact with the digital assistant 120 and the service component 125 via the terminal device 110 and/or an attached device of the terminal device 110.

In some embodiments, the digital assistant 120 and the service component 125 may be downloaded, installed at the terminal device 110. In some embodiments, the digital assistant 120 and the service component 125 may also be accessed in other ways, such as through a web page, etc. In the environment 100 of FIG. 1, in response to a service component 125 being started, the terminal device 110 may present a digital assistant 120 and an interface 150 of the service component 125.

The service components 125 include, but are not limited to, one or more of chat service components (also known as an instant messaging service IM component), a file service component, an audio-video conferencing service component, an email service component, a task service component, a calendar service component, a objectives and key result (OKR) service component, and so forth. It shall be understood that although a single service component is shown in FIG. 1, a plurality of service components may be installed on the terminal device 110 in practice. The service component may be integrated on a multifunctional collaboration platform. In a case where a plurality of service components is installed in the terminal device 110, the plurality of service components may be integrated on one or more multifunctional cooperation platforms. In a multifunctional cooperative platform, people can start different service components as required to complete corresponding information processing, sharing, communication, etc. The service component 125 may provide a content entity 126. The content entity 126 may be a content instance created on the service component 125 by a user 140 or another user. By way of example, depending on the type of service component 125, the content entity 126 may be a file (e.g., a word document, a pdf document, a presentation, a form document, and the like), an email, a message (e.g., a session message on an instant messaging service component), a calendar, a calendar, a task, an audio, a video, an image, and the like.

In some embodiments, the digital assistant 120 may be provided by a separate service component, or may be integrated in a certain service component 120 capable of providing a content entity. A service component for providing a client interface for a digital assistant may correspond to a single-function service component or a multi-function collaboration platform, such as an office suite or other collaboration platform capable of integrating multiple components. It can be understood that, similar to the service component, although a single digital assistant is shown in FIG. 1, there may actually be a plurality of digital assistants.

In some embodiments, the digital assistant 120 supports the use of plugins. Each plugin can provide one or more functions of a service component. Such plug-ins include, but are not limited to, one or more among a search plug-in, a contacts plug-in, a message plug-in, a document plug-in, a table plug-in, an email plug-in, a calendar plug-in, a calendar plug-in, a task plug-in, and the like.

The digital assistant 120 may be a user's intelligent assistant, which has an intelligent conversation and information processing capability. In the embodiments of the present disclosure, the digital assistant 120 is configured for interacting with the user 140, to assist the user 140 in using a terminal device or a service component. An interaction window with the digital assistant 120 may be presented in the client interface. In the interaction window, the user 140 may have a conversation with the digital assistant 120 by inputting a natural language, an image, an audio file, a video file, a web file, so as to instruct the digital assistant to assist in completing various tasks, including operations on the content entity 126.

In some embodiments, the digital assistant 120 may be included in a contact list of the current user 140 in an office suite, as a contact of the user 140, or in an information flow of a chat component. In some embodiments, the user 140 has a correspondence with the digital assistant 120. For example, a first digital assistant corresponds to a first user, a second digital assistant corresponds to a second user, and so on. In some embodiments, a first digital assistant may uniquely correspond to a first user, a second digital assistant may uniquely correspond to a second user, and so on. That is, the first digital assistant of the first user may be specific or exclusive to the first user. For example, in a process in which the first digital assistant provides assistance or services to the first user, the first digital assistant may utilize its historical interaction information with the first user, data authorized by the first user that it can access, its current interaction context with the first user, etc. If the first user is an individual or a person, the first digital assistant may be regarded as a personal digital assistant. It can be understood that, in the embodiment of the present disclosure, the first digital assistant accesses data to which it is granted authorization of the first user. It should be understood that “uniquely corresponding to” or similar expressions in this disclosure are not intended to limit that a first digital assistant is to be updated accordingly based on an interaction process between a first user and the first digital assistant. Of course, depending on the actual needs, the digital assistant 120 also need not be specific to the current user 140, but may be a general-purpose digital assistant.

In some embodiments, a plurality of interaction modes of the user 140 with the digital assistant 120 may be provided, and flexible switching between the plurality of interaction modes may be possible. In the event that a certain interaction mode is triggered, a corresponding interaction region is presented to facilitate interaction between the user 140 and the digital assistant 120. In different interaction modes, the user 140 and the digital assistant 120 interact in different manners, so that the interaction requirements in different application scenes can be flexibly adapted.

In some embodiments, an information processing service specific to user 140 can be provided based on historical interaction information of the user 140 with the digital assistant 120 and/or data range specific to the user 140. In some embodiments, historical interaction information that the user 140 has interacted with the digital assistant 120 in a plurality of interaction modes, respectively, may all be stored in association with the user 140. As such, in one of the plurality of interaction modes (anyone or a designated one), the digital assistant 120 may provide services to the user 140 based on historical interaction information stored in association with the user 140.

The digital assistant 120 may be invoked or awakened by an appropriate manner (e.g., a shortcut key, a button, or voice) to present an interaction window with the user 140. The interaction window with the digital assistant 120 may be opened by selecting the digital assistant 120. The interaction window may include interface elements for information interaction, such as an input box, a message list, a message bubble, and the like. In some other embodiments, the digital assistant 120 may be evoked via an entry control or a menu provided on the page, or may be evoked by entering a predetermined instruction.

The interaction window between the digital assistant 120 and the user 140 may include a session window, such as a session window in an instant messaging module in an instant messaging service component or target service component. In the session window, the interaction window between the digital assistant 120 and the user 140 may be presented in the form of a session message. Alternatively, or additionally, the interactive window between the digital assistant 120 and the user 140 may also include other types of windows, for example, a window in a floating window mode, where the user 140 may trigger the digital assistant 120 to perform a corresponding operation by inputting an instruction, selecting a shortcut instruction, or the like.

In some embodiments, the digital assistant 120 may support a session window interaction mode, also referred to as a session mode. In the interaction mode, a session window between the user 140 and the digital assistant 120 is presented, and in the session window, the user 140 interacts with the digital assistant 120 through a session message. In the session mode, the digital assistant 120 may perform a task according to a session message in the session window. In the interaction window, the user 140 inputs an interaction message and the digital assistant 120 provides a reply message in response to the user input.

In some embodiments, the session mode of the user 140 with the digital assistant 120 may be called or evoked in an appropriate manner (e.g., shortcut, button, or voice) to present a session window. A session window with the digital assistant 120 may be opened by selecting the digital assistant 120. The session window may include interface elements for information interaction, such as an input box, a message list, a message bubble, and so on.

In some embodiments, the digital assistant 120 may support an interaction mode of a floating window (or floating window), also referred to as a floating window mode. In a case in which the floating window mode is triggered, an operation panel (also referred to as a floating window) corresponding to the digital assistant 120 is presented, and the user 140 may send an instruction to the digital assistant 120 based on the operation panel. In some embodiments, the operation panel may include at least one candidate shortcut instruction. Alternatively, or additionally, the operation panel may include an input control for receiving instructions. In the floating window mode, the digital assistant 120 may perform a task according to an instruction sent by the user 140 through the operation panel.

In some embodiments, the floating window mode of user 140 with the digital assistant 120 may also be invoked or awakened in an appropriate manner (e.g., a shortcut, a button, or voice) to present a corresponding operation panel. In some embodiments, awakening the digital assistant 120 may be supported in a particular service component, such as in a file service component, to provide the floating window mode of interaction. In some embodiments, to trigger the floating window mode to present the operation panel corresponding to the digital assistant 120, an entry control for the digital assistant 120 may be presented in the service component interface. In response to detecting a trigger operation on the entry control, the floating window mode may be determined to be triggered, and the operation panel corresponding to the digital assistant 120 is presented in the target interface area.

In some embodiments as described below, for the purpose of discussion, the interaction window between the user and the digital assistant being a session window is mainly given as an example for description.

In some embodiments, the terminal device 110 communicates with the server 130 to enable provision of the services to the digital assistant 120 and the service component 125. The terminal device 110 may be any type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a game device, or any combination of the foregoing, including accessories and peripherals for these devices, or any combination thereof. In some embodiments, the terminal device 110 can also support any type of interface to a user (such as ‘wearable’ circuitry, etc.). The service components 130 may be various types of computing systems/servers capable of providing computing capabilities including, but not limited to, mainframes, edge computing nodes, computing devices in a cloud environment, etc.

It should be understood that the structure and function of the various elements in environment 100 are described for illustrative purposes only, and are not intended to imply any limitation on the scope of the disclosure.

As briefly described above, the terminal device or the application may provide a digital assistant-like function to a user to assist the user in using the terminal device or the application. The convenience of the interaction between the user and the digital assistant is a technical problem to be explored at present. Conventionally, the user interacts with the digital assistant through an inputting method of instant messaging (IM).

However, the two-line input box designed for instant messaging is not concise enough, and some functions provided by such input box may be unnecessary or rarely used in interaction with the digital assistant. Therefore, it is desirable to explore a more concise input modality for digital assistants. On the other hand, some of the functions needed or frequently used in the user's interaction with the digital assistant may not be efficiently used in a conventional input mode.

Embodiments of the present disclosure provide an improved solution for information interaction. According to various embodiments of the present disclosure, if an interaction between a user and a digital assistant is triggered, a scene selection entry, a local resource addition entry, and an input provision entry corresponding to a current input mode are presented in an interaction interface between the user and the digital assistant. The current input mode includes at least one of a voice input mode or a text input mode. The user may provide interaction information for the digital assistant via at least one of the scene selection entry, the local resource addition entry, and the input provision entry. In this way, the use of simple visual design organically combines various types of interaction entries between the user and the digital assistant, so that a simpler and pure form of input can be allowed for the user.

Some example embodiments of the present disclosure will be described below with continued reference to the drawings. It should be understood that the pages shown in the drawings are only examples, and a variety of page designs may exist in practice. Various graphical elements in a page may have different arrangements and different visual representations, in which one or more of which may be omitted or replaced, and one or more other elements may also be present. Embodiments of the present disclosure are not limited in this regard. Furthermore, in the following, example embodiments will be primarily described with respect to the terminal device 110. It should be understood that the actions described with respect to the terminal device 110 may be performed by an application, component, or suite (e.g., service component 125) on the terminal device 110, or may be performed by an application, component, or suite in conjunction with its server (e.g., server 130).

In some embodiments, if the interaction between the user 140 and the digital assistant is triggered, the terminal device 110 displays a scene selection entry, a local resource addition entry, and a first input provision entry corresponding to the first input mode in the interaction interface 150 between the user 140 and the digital assistant. The scene selection entry may be used to select one or more scenarios from a plurality of candidate scenarios, and the scenario herein refers to a set of tasks of the same type, that is, one scenario corresponds to a plurality of tasks of the same type. One or more scenes may be respectively configured with corresponding configuration information to perform corresponding types of tasks. Examples of scenes may include, but are not limited to, content creation, content understanding, work counseling, etc. A local resource addition entry is used for user selection of local resources at the terminal device 110. The input provision entry is used for providing user input in natural language.

The first input mode may be a voice input mode or a text input mode. In some embodiments, in addition to the entries as described above, the terminal device 110 may further display a mode switching control for switching from one input mode to another input mode.

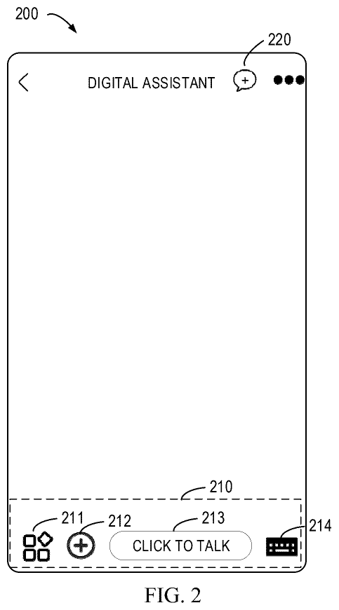

The following takes a voice input mode as an example. FIG. 2 illustrates a schematic diagram of an initial example interface 200 for performing information interaction according to some embodiments of the disclosure. As shown in FIG. 2, the terminal device 110 presents a scene selection entry 211, a local resource addition entry 212 (e.g., presented in the form of a “+” control), a voice recording entry 213, and a mode switching control 214 in the interface 200. The input provision entry in the voice input mode is a voice recording entry 213. If the user 140 clicks on the mode switching control 214, the terminal device 110 may switch to the text input mode, and display the input provision entry in the text input mode, i.e., the text entering entry, in the interface, as will be described below. In some embodiments, a new topic control may also be displayed in the interaction interface to start a new topic of a session between the user and the digital assistant. For instance, in the example of FIG. 2, a new topic control 220 is displayed in the interface 220. In such an embodiment, the new topic control is not displayed within the session window, but is instead displayed in a sidebar area of the session window. In this way, the interaction interface can be further made visually simpler and clearer.

In some embodiments, the scene selection entry, the local resource addition entry, and the first input provision entry are displayed in a first interface area extending along a horizontal direction in the interaction interface. For instance, in the example of FIG. 2, the scene selection entry 211, the local resource addition entry 212, the voice recording entry 213, and the mode switching control 214 are displayed in the interface area 210 extending along the horizontal direction. This interface area 210 is near the lower part of the interface.

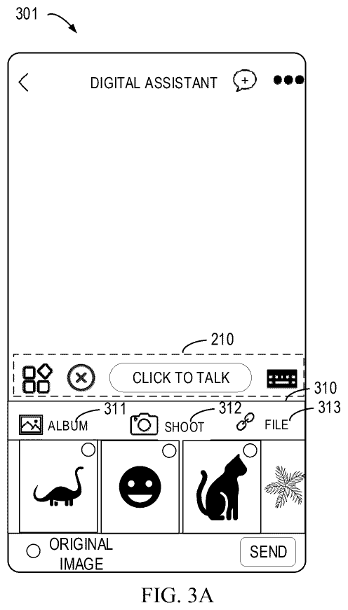

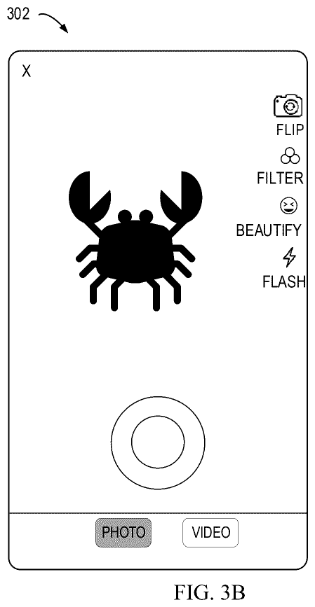

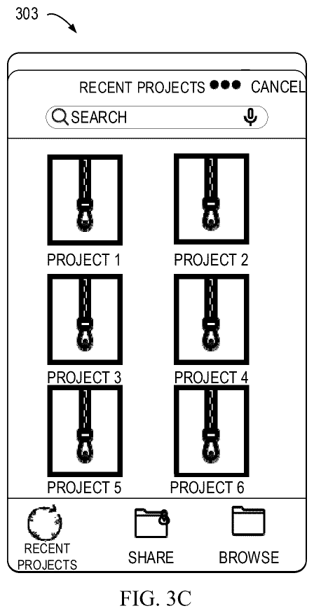

Some example embodiments regarding local resource addition entry will be described below with reference to FIGS. 3A to 3C. In some embodiments, if the user 140 clicks on the local resource entry, the terminal device 110 presents, in the second interface area, a corresponding control for adding a plurality of categories of local resources. FIGS. 3A to 3C illustrate schematic diagrams of example interfaces for performing information interactions according to some embodiments of the disclosure.

As shown in FIG. 3A to FIG. 3C, in response to the user 140 triggering the local resource entry 212, the terminal device 110 displays corresponding controls for adding local resources of a plurality of categories in the second interface area 310. For example, the terminal device 110 displays, in the second interface area 310, corresponding controls of a plurality of categories of local resources, such as an album control 311, a shooting control 312, and a file control 313. As shown in FIG. 3A, the second interface area 310 extends in a horizontal direction and is located below the first interface area 210.

In some embodiments, the terminal device 110 displays the album component 314 in the second interface area 310 in response to the user 140 clicking the album control 311. As shown in FIG. 3B, in response to the user 140 clicking the shooting control 312, the terminal device 110 evokes the shooting component. As shown in FIG. 3C, in response to the user 140 clicking on the file control 313, the terminal device 110 evokes a component for the system selecting a local file.

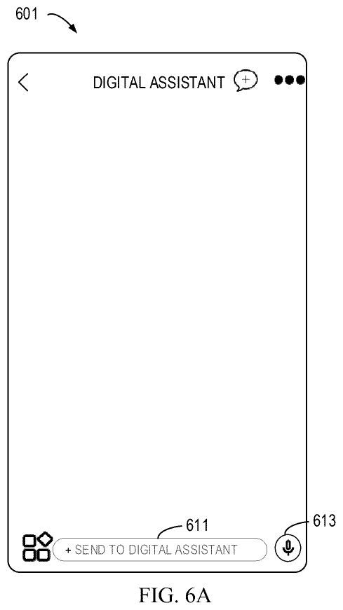

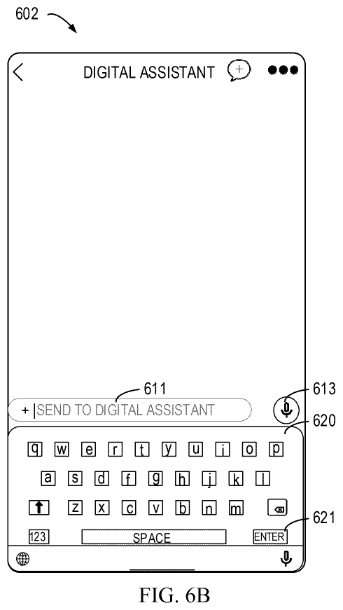

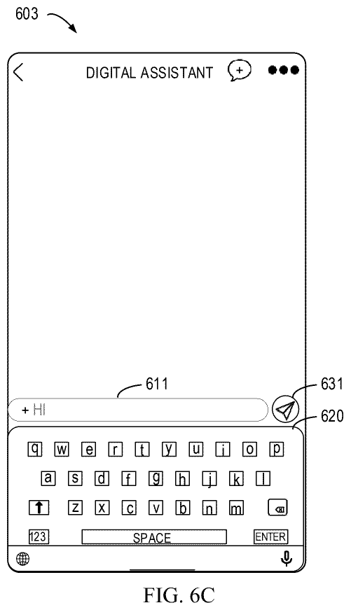

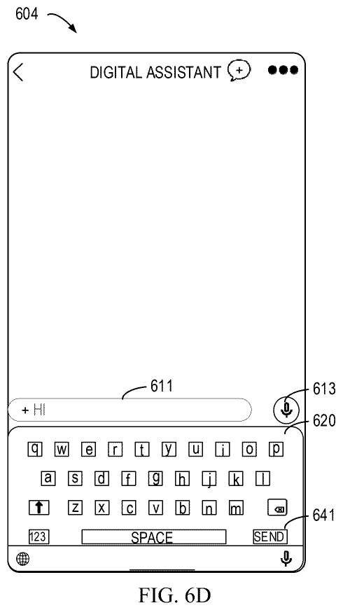

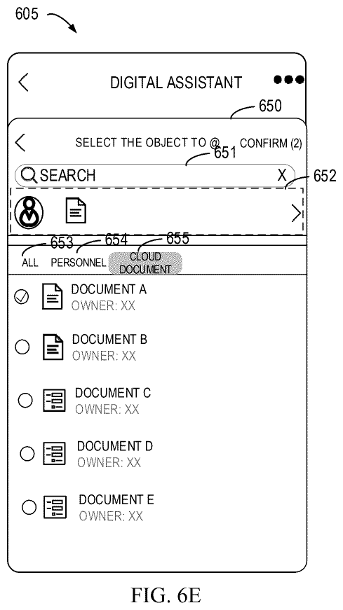

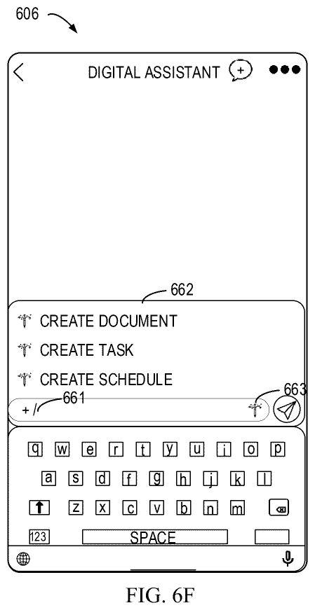

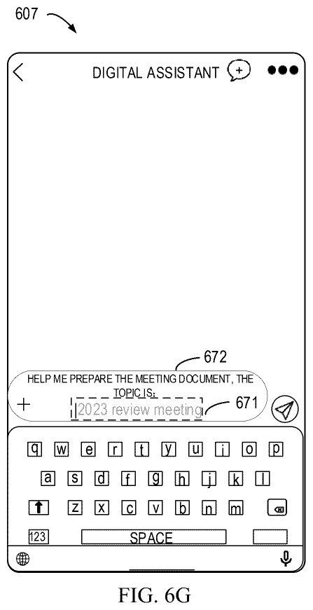

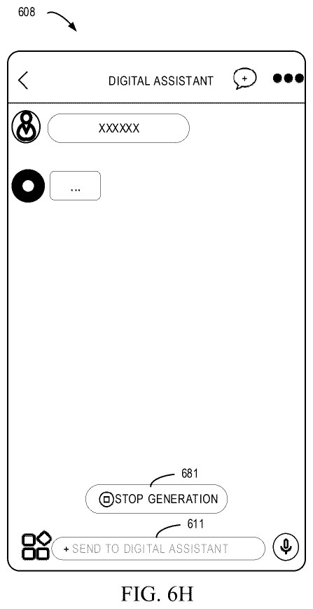

With continued reference to FIG. 2, in this example, the first input mode is a voice input mode and the first input provision entry is a voice recording entry 213. The user 140 clicks the voice recording entry 213, and may interact with the digital assistant in a voice form. In some embodiments, the first input mode is a text input mode, and the first input provision entry is a text entering entry. FIG. 6A illustrates an example interface in a text input mode. As illustrated in FIG. 6A, the user 140 clicks on a text entering entry 611 to interact with a digital assistant in the form of text. In some examples, the user 140 may click on the keyboard control 214, the terminal device 110 will display the switching to the text entering entry 611 in the interface 150. FIG. 6A will be described in detail below.

In some embodiments, the terminal device 110 receives interaction information between the user 140 and the digital assistant via at least one of a scene selection entry, a local resource addition entry, and an input provision entry. In some embodiments, in a case that the user 140 performs information interaction with the digital assistant in a voice input mode, the first input provision entry includes a voice recording entry. In such an embodiment, if the terminal device 110 receives a first predetermined operation for the voice recording entry, the terminal device 110 displays a flag indicating that voice input is being detected instead of the voice recording entry. The terminal device 110 will then display the text corresponding to the detected voice input. The terminal device 110 determines the detected voice input as the interaction information between the user 140 and the digital assistant, in response to a predetermined event.

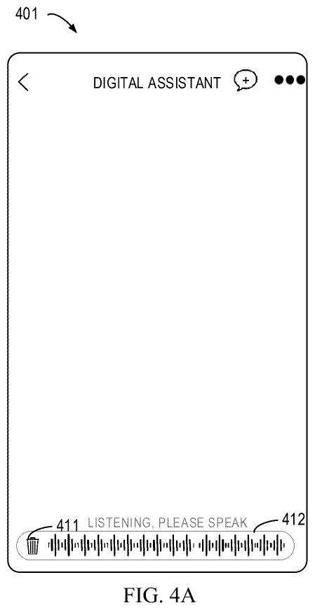

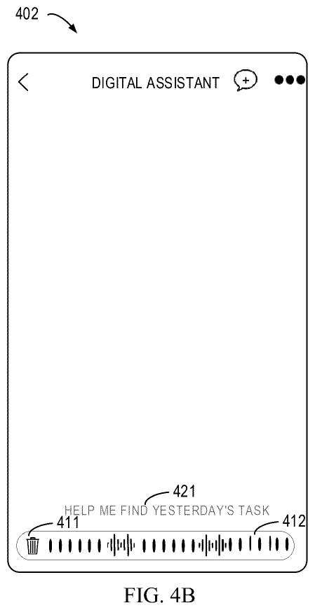

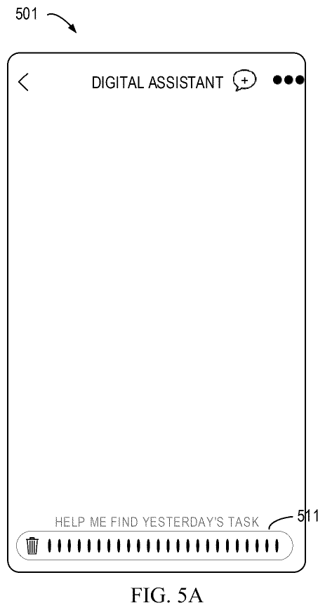

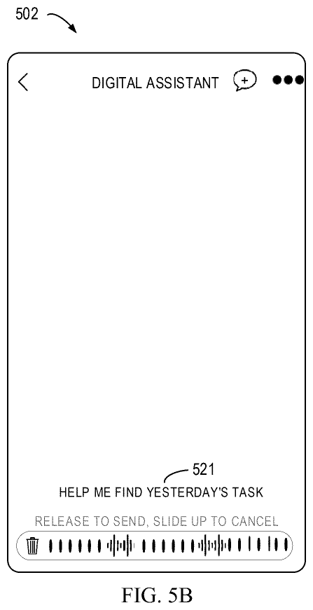

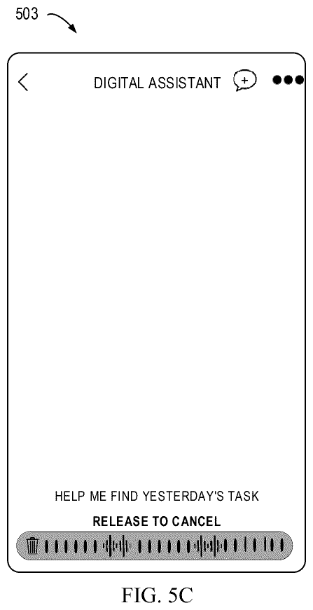

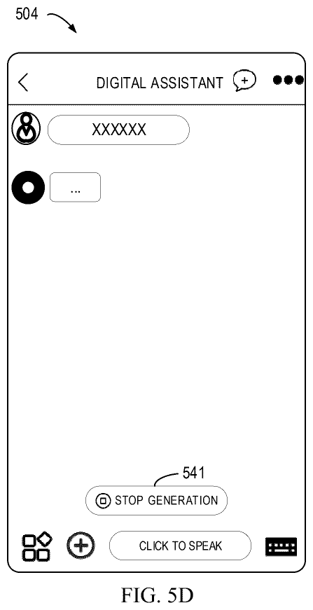

In some embodiments, the first predetermined operation includes a tap on a voice recording entry, or a continuous touch against the voice recording entry. If the first predetermined operation is a tap on the voice recording entry, the predetermined event is lasting for a predetermined duration without detecting the voice input from the user 140. If the first predetermined operation is a continuous touch against the voice recording entry, the predetermined event is the end of the continuous touch. The following will take a case where the terminal device 110 responds to a tap on the voice recording entry or the continuous touch against the voice recording entry as two examples, and the user 140 performing information interaction with the digital assistant in the voice input mode is described with reference to FIG. 4A to FIG. 5C.

In some embodiments, in a case that the terminal device 110 detects a tapping operation performed by the user 140 on the voice recording entry, the user 140 performs information interaction with the digital assistant in the voice input mode. An example is described with reference to FIGS. 4A to 4B. FIGS. 4A to 4B illustrate schematic diagrams of example interfaces for information interaction in the voice input mode according to some embodiments of the disclosure. Hereinafter, FIG. 4A to FIG. 4B will be described with reference to FIG. 2 and in terms of the terminal device 110 for the purpose of discussion, but this is only illustrative.

As shown in FIG. 4A to FIG. 4B, if the terminal device 110 receives a tap on the voice recording entry 213, the terminal device 110 will display a flag 412 on the interface 401 indicating that voice input is being detected in place of the voice recording entry 213. For example, if the terminal device 110 receives that the user 140 taps on the voice bar and enters the voice recording state. Accordingly, the terminal device 110 presents prompt information “Listening, please speak” on the interface 401.

In response to detecting the language of the user 140, the terminal device 110 may convert the voice recorded by the user 140 into text content in real time using the server 130. The terminal device 110 may transmit the recorded voice to the server 130. The server 130 may convert the voice into the corresponding text 421 and transmit the text 421 to the terminal device 110. The terminal device 110 displays the received text 421 on the interface 402. Alternatively, voice to text conversion may be performed by the terminal device 110. If no voice input is detected by the terminal device 110 for a predetermined duration, the detected voice input is determined as the interaction information between the user 140 and the digital assistant. For example, if the terminal device 110 detects a voice input for more than 3 seconds, the detected voice input is automatically sent.

In some embodiments, the terminal device 110 also presents the delete control 411 for the detected voice input in the presenting area of the flag 412. For example, if the user 140 clicks on the delete control 411, the recording may be cancelled, and the process returns to the initial state.

In some embodiments, in a case that the terminal device 110 detects a continuous touch of the user 140 for the voice recording entry, the user 140 performs information interaction with the digital assistant in the voice input mode. An example is described with reference to FIGS. 5A to 5D. FIGS. 5A to 5D illustrate schematic diagrams of example interfaces for information interaction in the voice input mode according to further embodiments of the present disclosure.

As shown in FIG. 5A to FIG. 5C, if the terminal device 110 receives a continuous touch against the voice recording entry 213, the terminal device 110 displays a flag 511 indicating that voice input is being detected on the interface 501 instead of the voice recording entry 213. For example, if the terminal device 110 receives that the user 140 continuously touch the voice bar, the terminal device 110 enters the voice recording state in the continuous touching process.

In response to detecting the voice of the user 140, the terminal device 110 may convert the voice recorded by the user 140 into text content in real time using the server 130. The terminal device 110 displays a text 521 corresponding to the voice of the user 140 on the interface 502. For example, if the user 140 says “please help me find yesterday's task” in voice form, the terminal device 110 may send the recorded voice to the server 130. The server 130 may convert the voice into corresponding text and send the resulting text to the terminal device 110 for display. Alternatively, the voice-to-text conversion may be performed by the terminal device 110. If the terminal device 110 detects the end of the continuous touch for the voice recording entry 213 by the user 140, the detected voice input will be determined as the interaction information of the user 140 with the digital assistant. For example, user 140 releases his/her finger to complete the sending.

In some examples, the terminal device 110 may cancel the sending based on detecting that a change in gesture (i.e., performing an upward swipe) of the user 140 during a continuous touch of the recording entry 213 in the process of the user 140 continuously touching the recording entry 213. In some embodiments, the voice input mode is presented by default on the interface 501. For example, in a case that a user's interaction with the digital assistant is triggered for the first time, the voice input mode can be presented by default. By prioritizing the voice input mode, the interaction efficiency between the user and the digital assistant can be improved. Especially, if the terminal device 110 is a mobile phone, voice input is more convenient for the user than text input.

In some embodiments, the terminal device 110 may store the first input mode which the user 140 last exited so that the user 140 enters the corresponding first input mode next time. In addition, a mode suitable for the user can be better matched.

In some examples, the terminal device 110 displays the text 521 corresponding to the voice content of the user 140 on the interface 502. The maximum height of an area for the terminal device 110 in which the text is displayed accounts for a certain proportion, for example 40%, of the height of the screen. If the converted text content exceeds the area of the text, the text is drawn upward (displayed in the form of “ . . . ”).

If the width of the current interaction interface 502 displayed by the terminal device 110 is greater than the threshold (for example, 1216 px), the width of the voice input entry (for example, the voice bar) displayed by the terminal device 110 is the first value (for example, 1200 px), and the width of the text input entry displayed by the terminal device 110 may be the second value (for example, 1168 px). If the width of the current interaction interface 150 displayed by the terminal device 110 is less than or equal to the threshold value, the width of the voice input entry (for example, the voice bar) displayed by the terminal device 110 and the width of the area of the text displayed by the terminal device 110 are adaptive.

It should be understood that the specific values described above with respect to scale, width, threshold, etc. are merely illustrative and are not intended to be limiting. Any suitable number may be employed in the embodiments of the present disclosure.

As shown in FIG. 5D, when the user 140 performs information interaction with the digital assistant in the voice input mode, a stop generation control 541 above the voice input entry 211 may be clicked to interrupt a task being executed by the digital assistant.

The embodiments were described above in which user 140 interacts with a digital assistant in a voice input mode. Information interaction by the user 140 with the digital assistant in a text input mode will be described below with reference to FIGS. 6A to 6H. The following discussion will refer to FIG. 2 for the purpose of discussion and will be described in terms of the terminal device 110.

The text input mode is described below as an example. FIGS. 6A to 6H illustrate schematic diagrams of example interfaces for information interaction in the text input mode according to some embodiments of the present disclosure. The first input mode includes a text input mode, and the first input provision entry includes a text recording entry. As shown in FIG. 6A, a terminal device 110 displays the text entering entry 611, the scene selection entry 211, and the switching control 613 for switching a voice input mode in the interaction interface 601 between the user 140 and the digital assistant.

In some embodiments, the terminal device 110 displays a keyboard area for entering text in response to a trigger of the text entering entry 611. As shown in FIG. 6B, upon the cursor enters the text entering entry 611 (input box), the terminal device 110 pops up the keyboard area 620 on the interface 602 and hides the scene selection entry 211.

In some embodiments, the terminal device 110, in response to receiving text entered in the keyboard area from the user 140, translates the previously displayed interface element into a confirmation control for the entered text. In other embodiments, the previously displayed interface elements include at least a switching control 613 for switching input modes, a keyboard element 621 in a keyboard area 620. In a schematic diagram of an interface 603 shown in FIG. 6C, for a keyboard area 620 popped up by the terminal device 110, the user 140 types (e.g., “hi”) at a text entering entry 611 (input box) based on the keyboard area 620. In response to the text input by the user 140, the terminal device 110 converts the previously displayed control 613 for selecting a voice input mode into a “send” control 631.

In the diagram of the interface 604 as illustrated in FIG. 6D, for a keyboard area 620 popped up by the terminal device 110, the user 140 types (e.g., “hi”) at a text entering entry 611 (input box) based on the keyboard area. The terminal device 110, in response to the text entered by the user 140, converts the keyboard element 621 (“Enter” element) displayed in the previous keyboard area 620 into a “sending” control 641. In such embodiments, in response to the user entering text in the keyboard area, the previously displayed interface element is converted into a confirmation control for entering text. Thus, there is no need to add an additional confirmation control (for example, a confirmation button) in the interface, thereby providing a simpler visual design for the user. For example, a more concise interface design is provided for the user.

In some embodiments, the terminal device 110 determines the text entered by the user 140 as the interaction information in response to the user 140 triggering the confirmation control.

In some embodiments, the terminal device 110 will display one or more options in response to detecting a mention operation on the text entering entry 611 (e.g., input box). As illustrated in FIG. 6E, one or more options correspond to other users or files that can be mentioned by the user. If the user 140 inputs a mention operation (e.g., “@”) in the text entering entry 611, the terminal device 110 displays a “mentioning menu 650” in the interface 605, the mentioning menu 650 including one or more options. For example, the mentioning menu 650 includes an all option 653, a personnel option 654, a cloud document option 655, etc. The terminal device 110 displays the selected person or cloud file in the lower area 652 of the search box 651. In some embodiments, the terminal device 110 determines the interaction information based on a user selection of one or more of the options and the text entered in the text entering entry 611.

In some embodiments, the terminal device 110 displays one or more candidate shortcut instructions in response to a second predetermined operation for a text entering entry. The one or more candidate shortcut instructions are related to the scene selected through the scene selection entry. In such embodiments, by introducing scene-based shortcut instructions, the user can be assisted in using the scene capabilities of the digital assistant at a lower threshold. This facilitates assisting user to better interact with the digital assistant.

In some embodiments, the second predetermined operation includes at least the terminal device 110 inputting a predetermined character in the text entering entry. As illustrated in the diagram of the interface 606 shown in FIG. 6F, the terminal device 110 inputs a predetermined character 661 (e.g., “/”) in the text entering entry 611. In some embodiments, the second predetermined operation at least further includes triggering a shortcut instruction selection control displayed in the text entering entry. As shown in FIG. 6F, the terminal device 110 displays a shortcut instruction selection control 663 in the text entering entry 611 in the interface 606.

In some examples, the terminal device 110 displays a candidate shortcut instruction menu 662 in response to the user 140 inputting a predetermined character 661 (e.g., “/”) in the text entering entry 611, or the user 140 clicking on the shortcut instruction selection control 663. The candidate shortcut instruction menu 662 includes one or more candidate shortcut instructions. In some embodiments, the terminal device 110 receives a selection of a shortcut instruction among one or more candidate shortcut instructions by the user, and determines interaction information based on the shortcut instruction selected by user 140.

In some examples, if the shortcut instruction selected by the user 140 is a shortcut instruction without a parameter, the shortcut instruction may be sent directly to the digital assistant for the digital assistant to process. For example, for shortcut instructions without parameters: “Summarize Recent Meeting”, it is sent directly. If the user 140 selects a short-cut instruction with parameters, the user 140 is required to further input. In a schematic diagram of an interface 607 as shown in FIG. 6G, for a shortcut instruction 672 with parameters: “Help me prepare a meeting document, the topic is:”, the user 140 is required to further input text 671 “2023 review meeting”.

As shown in the schematic diagram of the interface 608 in FIG. 6H, when the user 140 performs information interaction with the digital assistant in the text input mode, the generation stop control 681 above the text entering entry 611 may be clicked, so as to interrupt a task being executed by the digital assistant.

The foregoing describes embodiments in which the user 140 interacts with a digital assistant in a voice input mode, or a text input mode. The switch between the first input mode and the second input mode will be described below with reference to FIGS. 2 and 6B.

In some embodiments, the terminal device 110 presents a second input provision entry corresponding to the second input mode in response to the switch indication from the first input mode to the second input mode. Accordingly, the terminal device 110 stops displaying the first input entry and the scene selection entry. The second input provision entry is in another mode of the voice input mode or the text input mode, and the second input provision entry presented by the terminal device 110 is an input that has been activated to detect the user 140. In such embodiments, the mode switching control may be implemented as or replaced with an input provision entry in another input mode.

For example, through the user 140 clicking on the keyboard control 214, the voice input mode is converted into the text input mode. Accordingly, the cursor will focus automatically to the second input provision entry (e.g., input box) and the keyboard area is popped up. For another example, the user 140 clicks on the switching control 613 for switching to the voice input mode, and may switch from the text input mode to the voice input mode. Accordingly, the terminal device 110 directly enters the voice recording state and waits for the user 140 to speak.

In some embodiments, the scene selection entry, the local resource addition entry, the voice recording entry in the voice input mode, and the text entering entry in the text input mode may be displayed in the interaction interface. For example, the mode switching control 214 shown in FIG. 2 is implemented as, or replaced by, the text entering entry. In this case, the interface shown in FIG. 2 includes both an entry in the voice input mode and an entry in the text input mode. For another example, the mode switching control 613 shown in FIG. 6A may be implemented as, or replaced by the voice recording entry. In such an embodiment, the user can conveniently select which input mode to use to interact with the digital assistant. In this case, the interface shown in FIG. 6A includes both the entry in the voice input mode and the entry in the text input mode.

Additionally, in some embodiments, if the input provision entries in both modes are presented simultaneously, the input-provision entry in one mode may be highlighted relative to the input-provision entry in the other mode, e.g., occupying a larger presentation area. In the example of FIG. 2, the voice recording entry is highlighted relative to the text entering entry. As another example, in the example of FIG. 6A, the text entering entry is highlighted relative to the voice recording entry.

In conclusion, in this way, a form corresponding to an entry can be provided to a user in a more concise input. Meanwhile, in a manner of prioritizing the voice input mode, the interaction efficiency between the user and the digital assistant can be improved. By introducing scene-based shortcut instructions, it can help users interact with digital assistants faster with lower threshold.

### Example Processes

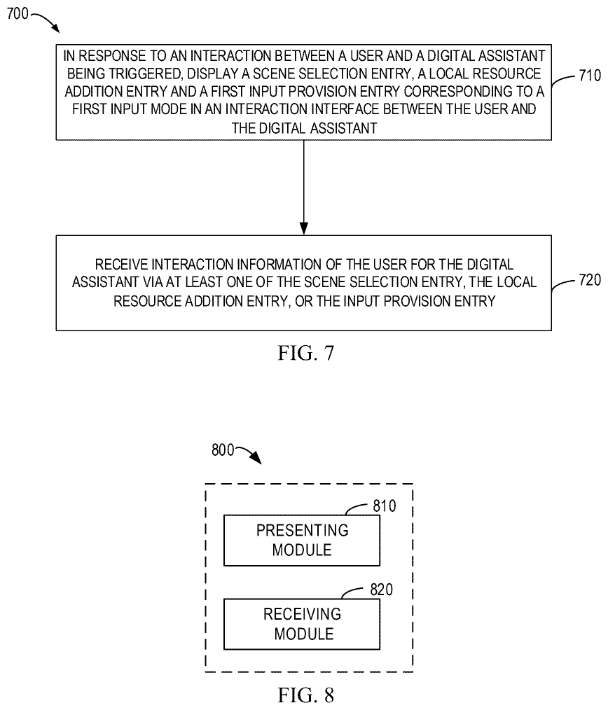

FIG. 7 illustrates a flowchart of an information interaction process 700 according to some embodiments of the disclosure. The process 700 may be implemented at terminal device 110 and/or at a digital assistant on terminal device 110. For example, the method 700 may be implemented by an application, component, or suite running at terminal device 110, or by such an application, component, or suite in conjunction with its server. The process 700 will be described below by taking the terminal device 110 as an example with reference to FIG. 1.

At block 710, the terminal device 110 displays, in response to an interaction between a user and a digital assistant being triggered, a scene selection entry, a local resource addition entry and a first input provision entry corresponding to a first input mode in an interaction interface between the user and the digital assistant, the first input mode comprising at least one of a voice input mode or a text input mode.

At block 720, the terminal device 110 receives interaction information of the user for the digital assistant via at least one of the scene selection entry, the local resource addition entry, and the input provision entry.

In some embodiments, the first input mode includes the voice input mode, and the first input provision entry comprises the voice recording entry, and receiving the interaction information of the user for the digital assistant includes: in response to a first predetermined operation on the voice recording entry, displaying a flag indicating that voice input is being detected in place of the voice recording entry; displaying text corresponding to the detected voice input; and in response to a predetermined event, determining the detected voice input as the interaction information.

In some embodiments, the first predetermined operation includes a tap on the voice recording entry, the predetermined event includes lasting for a predetermined duration without detecting voice input, and the process 700 further includes displaying a deletion control for the detected voice input in a display area of the flag.

In some embodiments, the first predetermined operation includes a continuous touch for the voice recording entry, and the predetermined event includes the end of continuous touch.

In some embodiments, the voice input mode is displayed by default.

In some embodiments, the first input mode includes the text input mode, and the first input provision entry includes a text entering entry, and receiving the interaction information of the user for the digital assistant includes: in response to a trigger of the text entering entry, displaying a keyboard area for entering text; in response to receiving text via the keyboard area, converting a previously displayed interface element into a confirmation control for the entered text; and in response to a trigger of the confirmation control, determining the entered text as the interaction information.

In some embodiments, the previously exposed interface elements include at least one of the following: a switching control for switching input modes, and a keyboard element in the keyboard area.

In some embodiments, receiving the interaction information of the user for the digital assistant includes: in response to detecting a mention operation in the text entering entry, displaying one or more options, the options corresponding to other users or files capable of being mentioned by the user; and determining the interaction information based on user selection of the one or more options and the entered text in the text entering entry.

In some embodiments, receiving the interaction information of the user for the digital assistant includes: in response to a second predetermined operation on the text entering entry, displaying one or more candidate shortcut instructions, the one or more candidate shortcut instructions relating to a scene selected via the scene selection entry; receiving a selection of a shortcut instruction in the one or more candidate shortcut instructions; and determining the interaction information based on the selected shortcut instruction.

In some embodiments, the second predetermined operation includes at least one of the following: inputting a predetermined character in the text entering entry, or triggering a shortcut instruction selection control displayed in the text entering entry.

In some embodiments, the scene selection entry, the local resource addition entry, or the first input provision entry are displayed in a first interface area extending along a horizontal direction in the interaction interface, and the method further includes: in response to a trigger of the local resource addition entry, displaying a corresponding control for adding a plurality of types of local resources in a second interface area, the second interface area extending along the horizontal direction and located below the first interface area.

In some embodiments, the process 700 further includes: in response to a switching indication of switching from the first input mode to a second input mode, displaying a second input provision entry corresponding to the second input mode, and stopping displaying the first input provision entry and the scene selection entry, wherein the second input provision entry is another one of the voice input mode or the text input mode, and the displayed second input provision entry has been activated to detect a user input.

### Example Apparatus and Device

FIG. 8 illustrates a schematic structural block diagram of an apparatus 800 of information interaction according to some embodiments of the present disclosure. The apparatus 800 may be implemented as or included in a terminal device 110. The various modules/components in the apparatus 800 may be implemented by hardware, software, firmware, or any combination thereof.

As shown in the figure, the apparatus 800 includes a display module 810 configured to, in response to a trigger of interaction between a user and a digital assistant, display a scene selection entry, a local resource addition entry and a first input provision entry corresponding to a first input mode in an interaction interface between the user and the digital assistant, the first input mode including at least one of a voice input mode or a text input mode. The apparatus 800 also includes a receiving module 820 configured to receive interaction information of the user for the digital assistant via at least one of the scene selection entry, the local resource addition entry, and the input provision entry.

In some embodiments, the first input mode includes the voice input mode and the first input provision entry comprises a voice recording entry, and the receiving module 820 is further configured to, in response to a first predetermined operation on the voice recording entry, display a flag indicating that voice input is being detected in place of the voice recording entry; display text corresponding to the detected voice input; and in response to a predetermined event, determine the detected voice input as the interaction information.

In some embodiments, the first predetermined operation includes a tap on the voice recording entry, the predetermined event includes lasting for a predetermined duration without detecting voice input, and the presentation module 810 is further configured to display a deletion control for the detected voice input in a display area of the flag.

In some embodiments, the first predetermined operation includes continuous touch for the voice recording entry, and the predetermined event includes an end of the continuous touch.

In some embodiments, the voice input mode is displayed by default.

In some embodiments, the first input mode includes the text input mode, and the first input provision entry comprises a text entering entry, and the receiving module 820 is further configured to, in response to a trigger of the text entering entry, display a keyboard area for entering text; in response to receiving text via the keyboard area, convert a previously displayed interface element into a confirmation control for the entered text; and in response to a trigger of the confirmation control, determine the entered text as the interaction information.

In some embodiments, the previously displayed interface element includes at least one of the following: a switching control for switching input modes, and a keyboard element in the keyboard area.

In some embodiments, the receiving module 820 is further configured to, in response to detecting a mention operation on the text entering entry, display one or more options, the options corresponding to other users or files capable of being mentioned by the user; and determine the interaction information based on user selection of the one or more options and the entered text in the text entering entry.

In some embodiments, the receiving module 820 is further configured to, in response to a second predetermined operation on the text entering entry, display one or more candidate shortcut instructions, the one or more candidate shortcut instructions relating to a scene selected via the scene selection entry; receive a selection of a shortcut instruction in the one or more candidate shortcut instructions; and determine the interaction information based on the selected shortcut instruction.

In some embodiments, the second predetermined operation includes at least one of the following: inputting a predetermined character in the text entering entry, or triggering a shortcut instruction selection control displayed in the text entering entry.

In some embodiments, the scene selection entry, the local resource addition entry, or the first input provision entry are displayed in a first interface area extending along a horizontal direction in the interaction interface. The display module 810 is further configured to, in response to a trigger of the local resource addition entry, display a corresponding control for adding a plurality of types of local resources in a second interface area, and the second interface area extending along the horizontal direction and located below the first interface area.

In some embodiments, the display module 810 is further configured to, in response to a switching indication of switching from the first input mode to a second input mode, display a second input provision entry corresponding to the second input mode, and stop displaying the first input provision entry and the scene selection entry, wherein the second input provision entry is another one of the voice input mode or the text input mode, and the displayed second input provision entry has been activated to detect a user input.

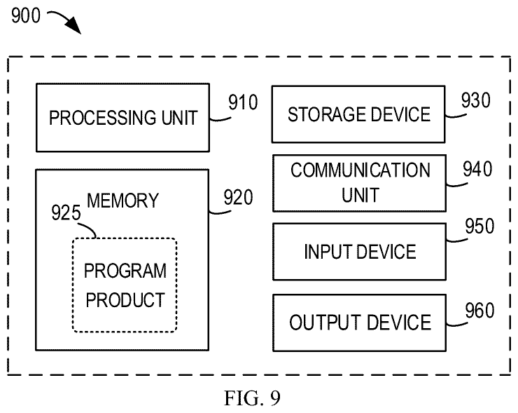

FIG. 9 illustrates a block diagram illustrating an electronic device 900 in which one or more embodiments of the present disclosure may be implemented. It should be appreciated that the electronic device 900 shown in FIG. 9 is merely illustrative and should not constitute any limitation on the functionality and scope of the embodiments described herein. The electronic device 900 shown in FIG. 9 may be used to implement the terminal device 110 of FIG. 1 or the apparatus 800 shown in FIG. 8.

As shown in FIG. 9, the electronic device 900 is in the form of a general-purpose electronic device. Components of the electronic device 900 may include, but are not limited to, one or more processors or processing units 910, a memory 920, a storage device 930, one or more communications units 940, one or more input devices 950, and one or more output devices 960. The processing unit 910 may be an actual or virtual processor and can perform various processes according to programs stored in the memory 920. In a multiprocessor system, a plurality of processing units executes computer executable instructions in parallel, so as to improve the parallel processing capability of the electronic device 900.

The electronic device 900 typically includes a number of computer storage media. Such media may be any available media that are accessible by electronic device 900, including, but not limited to, volatile and non-volatile media, removable and non-removable media. The memory 920 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 930 may be a removable or non-removable medium and may include a machine-readable medium such as a flash drive, a magnetic disk, or any other medium that can be used to store information and/or data and that can be accessed within the electronic device 900.

The electronic device 900 may further include additional removable/non-removable, volatile/nonvolatile storage media. Although not shown in FIG. 9, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 920 may include a computer program product 925 having one or more program modules configured to perform various methods or actions of various embodiments of the present disclosure.

The communication unit 940 implements communication with other electronic devices through a communication medium. In addition, functions of components of the electronic device 900 may be implemented by a single computing cluster or a plurality of computing machines, and these computing machines can communicate through a communication connection. Thus, the electronic device 900 may operate in a networked environment using logical connections to one or more other servers, network personal computers (PCs), or another network node.

The input device 950 may be one or more input devices such as a mouse, keyboard, trackball, etc. The output device 960 may be one or more output devices such as a display, speaker, printer, etc. The electronic device 900 may also communicate with one or more external devices (not shown) such as a storage device, a display device, or the like through the communication unit 940 as required, and communicate with one or more devices that enable a user to interact with the electronic device 900, or communicate with any device (e.g., a network card, a modem, or the like) that enables the electronic device 900 to communicate with one or more other electronic devices. Such communication may be performed via an input/output (I/O) interface (not shown).

According to an example implementation of the present disclosure, a computer readable storage medium is provided, on which a computer-executable instruction is stored, wherein the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method of information interaction, comprising:
in response to an interaction between a user and a digital assistant being triggered, displaying a scene selection entry, a local resource addition entry and a first input provision entry corresponding to a first input mode in an interaction interface between the user and the digital assistant, the first input mode comprising at least one of a voice input mode or a text input mode; and
receiving interaction information of the user for the digital assistant via at least one of the scene selection entry, the local resource addition entry, and the first input provision entry.

2. The method of claim 1, wherein the first input mode comprises the voice input mode, and the first input provision entry comprises a voice recording entry, and receiving the interaction information of the user for the digital assistant comprises:
in response to a first predetermined operation on the voice recording entry, displaying a flag indicating that voice input is being detected in place of the voice recording entry;
displaying text corresponding to the detected voice input; and
in response to a predetermined event, determining the detected voice input as the interaction information.

3. The method of claim 2, wherein the first predetermined operation comprises a tap on the voice recording entry, the predetermined event comprises lasting for a predetermined duration without detecting voice input,
the method further comprises:
displaying a deletion control for the detected voice input in a display area of the flag.

4. The method of claim 2, wherein the first predetermined operation comprises a continuous touch for the voice recording entry, and
the predetermined event comprises an end of the continuous touch.

5. The method of claim 2, wherein the voice input mode is displayed by default.

6. The method of claim 1, wherein the first input mode comprises the text input mode, and the first input provision entry comprises a text entering entry, and receiving the interaction information of the user for the digital assistant comprises:
in response to a trigger of the text entering entry, displaying a keyboard area for entering text;
in response to receiving entered text via the keyboard area, converting a previously displayed interface element into a confirmation control for the entered text; and
in response to a trigger of the confirmation control, determining the entered text as the interaction information.

7. The method of claim 6, wherein the previously displayed interface element comprises at least one of:
a switching control for switching input modes, or
a keyboard element in the keyboard area.

8. The method of claim 6, wherein receiving the interaction information of the user for the digital assistant comprises:
in response to detecting a mention operation in the text entering entry, displaying one or more options, the one or more options corresponding to other users or files capable of being mentioned by the user; and
determining the interaction information based on user selection of the one or more options and the entered text in the text entering entry.

9. The method of claim 6, wherein receiving the interaction information of the user for the digital assistant comprises:
in response to a second predetermined operation on the text entering entry, displaying one or more candidate shortcut instructions, the one or more candidate shortcut instructions relating to a scene selected via the scene selection entry;
receiving a selection of a shortcut instruction in the one or more candidate shortcut instructions; and
determining the interaction information based on the selected shortcut instruction.

10. The method of claim 9, wherein the second predetermined operation comprises at least one of:
inputting a predetermined character in the text entering entry, or
triggering a shortcut instruction selection control displayed in the text entering entry.

11. The method of claim 1, wherein the scene selection entry, the local resource addition entry, or the first input provision entry are displayed in a first interface area extending along a horizontal direction in the interaction interface, and the method further comprises:
in response to a trigger of the local resource addition entry, displaying a corresponding control for adding a plurality of types of local resources in a second interface area, the second interface area extending along the horizontal direction and located below the first interface area.

12. The method of claim 1, further comprising:
in response to a switching indication of switching from the first input mode to a second input mode, displaying a second input provision entry corresponding to the second input mode, and stopping displaying the first input provision entry and the scene selection entry,
wherein the second input provision entry is another one of the voice input mode or the text input mode, and the displayed second input provision entry has been activated to detect a user input.

13. An electronic device, comprising:
at least one processing unit;
at least one memory coupled to the at least one processing unit and storing instructions for execution by the at least one processing unit, wherein the instructions, when executed by the at least one processing unit, cause the electronic device to perform at least:
in response to an interaction between a user and a digital assistant being triggered, displaying a scene selection entry, a local resource addition entry and a first input provision entry corresponding to a first input mode in an interaction interface between the user and the digital assistant, the first input mode comprising at least one of a voice input mode or a text input mode; and
receiving interaction information of the user for the digital assistant via at least one of the scene selection entry, the local resource addition entry, and the first input provision entry.

14. The electronic device of claim 13, wherein the first input mode comprises the voice input mode, and the first input provision entry comprises a voice recording entry, and receiving the interaction information of the user for the digital assistant comprises:
in response to a first predetermined operation on the voice recording entry, displaying a flag indicating that voice input is being detected in place of the voice recording entry;
displaying text corresponding to the detected voice input; and
in response to a predetermined event, determining the detected voice input as the interaction information.

15. The electronic device of claim 14, wherein the first predetermined operation comprises a tap on the voice recording entry, the predetermined event comprises lasting for a predetermined duration without detecting voice input,
wherein the instructions, when executed by the at least one processing unit, cause the electronic device to further perform:
displaying a deletion control for the detected voice input in a display area of the flag.

16. The electronic device of claim 14, wherein the first predetermined operation comprises a continuous touch for the voice recording entry, and
the predetermined event comprises an end of the continuous touch.

17. The electronic device of claim 14, wherein the voice input mode is displayed by default.

18. The electronic device of claim 13, wherein the first input mode comprises the text input mode, and the first input provision entry comprises a text entering entry, and receiving the interaction information of the user for the digital assistant comprises:
in response to a trigger of the text entering entry, displaying a keyboard area for entering text;
in response to receiving entered text via the keyboard area, converting a previously displayed interface element into a confirmation control for the entered text; and
in response to a trigger of the confirmation control, determining the entered text as the interaction information.

19. The electronic device of claim 18, wherein the previously displayed interface element comprises at least one of:
a switching control for switching input modes, or
a keyboard element in the keyboard area.

20. A non-transitory computer readable storage medium having a computer program stored thereon, wherein the computer program is executable by a processor to implement at least:
in response to an interaction between a user and a digital assistant being triggered, displaying a scene selection entry, a local resource addition entry and a first input provision entry corresponding to a first input mode in an interaction interface between the user and the digital assistant, the first input mode comprising at least one of a voice input mode or a text input mode; and
receiving interaction information of the user for the digital assistant via at least one of the scene selection entry, the local resource addition entry, and the first input provision entry.
